(19) United States
(12) Patent Application Publication
(10) Pub. No.: US 2025/0149704 A1
(43) Pub. Date: May 8, 2025

(54) IN-VEHICLE BATTERY PACK STRUCTURE

(71) Applicant: TOYOTA JIDOSHA KABUSHIKI KAISHA, Toyota-shi (JP)

(72) Inventors: Naofumi Nomura, Nagakute-shi (JP); Yuta Arima, Toyota-shi (JP); Kazuaki Okudaira, Miyoshi-shi (JP); Tomoki Nakayama, Toyota-shi (JP); Satoshi Sawatani, Nukata-gun (JP); Nobuyasu Nishiki, Toyokawa-shi (JP)

(73) Assignee: TOYOTA JIDOSHA KABUSHIKI KAISHA, Toyota-shi (JP)

(21) Appl. No.: 18/779,266

(22) Filed: Jul. 22, 2024

(30) Foreign Application Priority Data
Nov. 2, 2023 (JP) 2023-188321

(51) Int. Cl. H01M 50/233; H01M 50/244; H01M 50/249; H01M 50/262; H01M 50/271

(52) U.S. Cl. CPC H01M 50/233; H01M 50/244; H01M 50/249; H01M 50/262; H01M 50/271

(57) ABSTRACT

The end plate is disposed on a side surface of the battery stack and is fixed to the lower case. The inner reinforcement is fixedly disposed inside the lower case. The outer reinforcement is fixedly disposed on the outer side of the lower case. The battery stack bracket connects the end plate and the inner reinforcement. The vehicle mounting bracket is fixed to the outer reinforcement and is attached to the vehicle body. The stiffness of the end plate is higher than the stiffness of the lower case, the inner reinforcement, the outer reinforcement, the battery stack bracket, and the vehicle mounting bracket, respectively.

### CROSS-REFERENCE TO RELATED APPLICATION

This application claims priority to Japanese Patent Application No. 2023-188321 filed on Nov. 2, 2023, incorporated herein by reference in its entirety.

### BACKGROUND

### 1. Technical Field

The present disclosure relates to an in-vehicle battery pack structure.

### 2. Description of Related Art

Vehicles provided with batteries are known. Japanese Unexamined Patent Application Publication No. 2022-111787 (JP 2022-111787 A), for example, discloses a vehicle-mounted battery pack. The vehicle-mounted battery pack according to JP 2022-111787 A includes a battery tray constituted of a floor portion disposed under a floor of a vehicle and a frame body. The frame body includes a side frame provided on at least the right and left sides of the floor portion in the vehicle width direction and attached to the vehicle. In JP 2022-111787 A, the battery tray includes a battery arrangement region portion which is provided at the center in the vehicle width direction and on which a battery module composed of a plurality of batteries is placed, and an impact absorbing region portion provided on the outer side of the battery arrangement region portion in the vehicle width direction. The side frame includes an overhang portion in which a lid portion is fixed to an upper portion of a side of the battery module and which overhangs toward the outer side in the vehicle width direction from the lid portion. In the technology according to JP 2022-111787 A, in addition, a lower cross member and an upper cross member are disposed so that the battery module can be stably fixed to the battery arrangement region portion.

### SUMMARY

In the technology according to JP 2022-111787 A, the lower cross member and the upper cross member are disposed between the overhanging portion and the battery module. Thus, in the technology according to JP 2022-111787 A, there is a fear that the lower cross member and the upper cross member apply a load (impact force; impact load) to the battery module when a load is input from a side of the vehicle due to a side collision or the like. Thus, in the technology according to JP 2022-111787 A, there is a possibility that it is not possible to suppress an impact load being applied to a battery stack (battery module) when an impact load is applied to the vehicle.

The present disclosure provides an in-vehicle battery pack structure capable of suppressing an impact load being applied to a battery stack even when an impact load is applied to a vehicle.

An aspect of the present disclosure provides an in-vehicle battery pack structure including:
a battery stack;
an end plate disposed on a side surface of the battery stack and fixed to a lower case that accommodates the battery stack;
an inner reinforcement formed in a bent plate shape and fixedly disposed on an inner side of the lower case;
an outer reinforcement formed in a bent plate shape and fixedly disposed on an outer side of the lower case so as to face the inner reinforcement with a wall surface of the lower case sandwiched therebetween;
a battery stack bracket that couples the end plate and the inner reinforcement; and
a vehicle mounting bracket fixed to the outer reinforcement on at least a side wall of the outer reinforcement and attached to a vehicle body, in which
the end plate is formed such that a rigidity of the end plate is higher than a rigidity of each of the lower case, the inner reinforcement, the outer reinforcement, the battery stack bracket, and the vehicle mounting bracket.

According to the present disclosure, it is possible to provide an in-vehicle battery pack structure capable of suppressing an impact load being applied to a battery stack even when an impact load is applied to a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an in-vehicle battery pack structure according to a first embodiment;

FIG. 2 is a diagram illustrating a closed cross-sectional structure formed in an in-vehicle battery pack structure according to Embodiment 1;

FIG. 3 is a diagram for explaining a behavior of an in-vehicle battery pack structure when an impact load is applied to a vehicle from a side surface in Embodiment 1;

FIG. 4 is a diagram for describing a behavior of an in-vehicle battery pack structure when an impact load is applied to a vehicle from a lower surface in Embodiment 1; and

FIG. 5 is a diagram for describing the behavior of the in-vehicle battery pack structure when vibration occurs in the vehicle in the first embodiment.

### DETAILED DESCRIPTION OF EMBODIMENTS

Hereinafter, embodiments of the present disclosure will be described with reference to the drawings. However, the present disclosure is not limited to the following embodiments. Further, for clarity of explanation, the following description and the drawings are simplified as appropriate.

### Embodiment 1

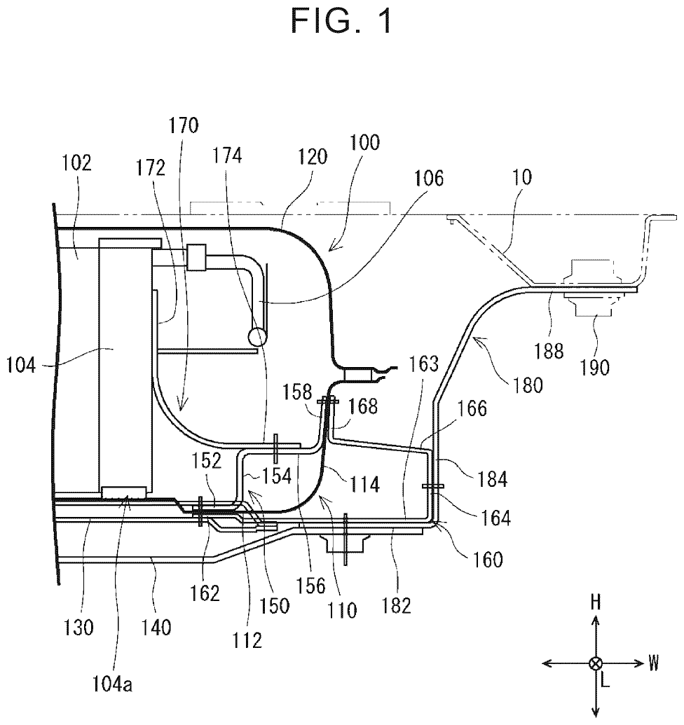

FIG. 1 is a diagram illustrating a configuration of an in-vehicle battery pack structure 100 according to a first embodiment. FIG. 1 shows a state in which an in-vehicle battery pack structure 100 is mounted on a vehicle. FIG. 1 is a view of a vehicle on which an in-vehicle battery pack structure 100 is mounted as viewed from the front-rear direction. The left-right direction in FIG. 1 corresponds to the width direction of the vehicle. The upward direction in FIG. 1 corresponds to the upward direction of the vehicle. An arrow W direction shown in the drawing corresponds to a width direction of the vehicle, an arrow H direction corresponds to a height direction of the vehicle, and an arrow L direction (a direction along a direction from the front of the paper surface toward the depth) corresponds to a front-rear direction of the vehicle.

The in-vehicle battery pack structure 100 includes a battery stack 102. Here, the battery stack 102 is arranged so as to extend in the width direction of the vehicle (the left-right direction in FIG. 1). Therefore, the in-vehicle battery pack structure 100 is arranged so as to extend in the width direction of the vehicle (the left-right direction in FIG. 1). Note that FIG. 1 shows only the structure of one end portion in the width direction of the in-vehicle battery pack structure 100 (battery stack 102). However, the in-vehicle battery pack structure 100 also has a structure substantially similar to the structure shown in FIG. 1 at the other end. For example, when FIG. 1 is a front view from the rear of the vehicle, FIG. 1 shows an in-vehicle battery pack structure 100 in the vicinity of the right side surface of the vehicle. In other words, FIG. 1 shows an in-vehicle battery pack structure 100 in the vicinity of the right side surface of the battery stack 102. In the following description, an example in which FIG. 1 is a view looking forward from the rear of the vehicle and shows an in-vehicle battery pack structure 100 in the vicinity of the right side surface of the vehicle will be described.

The in-vehicle battery pack structure 100 includes an end plate 104, a battery wiring 106, a lower case 110, an upper case 120, a cooling mechanism 130, and a share panel 140. The end plate 104 is disposed on a side surface of the battery stack 102. The lower case 110 and the upper case 120 accommodate the battery stack 102, the end plate 104, and the battery wiring 106. Accordingly, the battery stack 102 is disposed inside the lower case 110 and the upper case 120.

The lower case 110 and the upper case 120 are thin-plate containers. The lower case 110 has a bottom surface 112 and a side surface 114. The bottom surface 112 is formed in a plate shape extending in the width direction. The side surface 114 is formed in a plate shape so as to stand upwards along the peripheral edge of the bottom surface 112. Note that the shape of the upper case 120 may be substantially such that the lower case 110 is upside down.

The end plate 104 is fixed to the bottom surface 112 of the lower case 110 by, for example, an adhesive 104a made of a thermally conductive material. Similarly to the end plate 104, the battery stack 102 may be fixed to the bottom surface 112 of the lower case 110 by an adhesive which is a heat conductive material.

The cooling mechanism 130 may have a structure that allows coolant to pass therethrough, such as a cooling pipe. The cooling mechanism 130 is disposed below the bottom surface 112 of the lower case 110. The cooling mechanism 130 is disposed below the battery stack 102 via the bottom surface 112 of the lower case 110. As a result, the battery stack 102 is cooled by the cooling mechanism 130 via the lower case 110. The share panel 140 is disposed below the cooling mechanism 130 and protects the cooling mechanism 130.

The in-vehicle battery pack structure 100 includes an inner reinforcement 150, an outer reinforcement 160, a battery stack bracket 170, and a vehicle mounting bracket 180. The inner reinforcement 150, the outer reinforcement 160, the battery stack bracket 170, and the vehicle mounting bracket 180 are disposed in the vicinity of the side surface of the battery stack 102. The inner reinforcement 150 and the outer reinforcement 160 are reinforcing members.

The inner reinforcement 150 is fixedly disposed inside the lower case 110. The outer reinforcement 160 is fixed to the outside of the lower case 110 so as to face the inner reinforcement 150 with the wall surface (the bottom surface 112 and the side surface 114) of the lower case 110 interposed therebetween. The battery stack bracket 170 is configured to couple the end plate 104 and the inner reinforcement 150. The vehicle mounting bracket 180 is fixed to the outer reinforcement 160 by at least a side wall of the 15 outer reinforcement 160, and is attached to the vehicle body 10 such as a body. In other words, the in-vehicle battery pack structure 100 is attached to the vehicle body 10 by the vehicle mounting bracket 180.

The end plate 104 is formed so that the rigidity of the end plate 104 is higher than the rigidity of each of the lower case 110, the inner reinforcement 150, the outer reinforcement 160, the battery stack bracket 170, and the vehicle mounting bracket 180. The end plate 104 is formed of, for example, a solid resin or the like, but is not limited thereto.

The inner reinforcement 150 is fixed to the bottom surface 112 and the side surface 114 of the lower case 110 inside the lower case 110. The inner reinforcement 150 is formed in a bent plate shape. The inner reinforcement 150 includes a bottom surface connecting portion 152, a side wall portion 154, an upper surface portion 156, and a side surface connecting portion 158. The bottom surface connecting portion 152 is formed so as to extend in the width direction along the bottom surface 112 of the lower case 110. The bottom surface connecting portion 152 is connected to the bottom surface 112 of the lower case 110 by joining, fastening, or the like. The side wall portion 154 is formed so as to extend 30 upward from an end portion of the bottom surface connecting portion 152 on the side of the side surface 114 of the lower case 110 (a right end portion in FIG. 1, that is, an end portion on the side surface side of the vehicle). The upper surface portion 156 is formed so as to extend in the width direction from the upper end of the side wall portion 154 toward the side surface 114 of the lower case 110 (in the right direction in FIG. 1, that is, toward the side surface side of the vehicle). The side surface connecting portion 158 is formed so as to extend upward along the side surface 114 of the lower case 110 from an end portion of the upper surface portion 156 on the side surface 114 of the lower case 110 (an end portion on the right side in FIG. 1, that is, an end portion on the side surface side of the vehicle). That is, the upper surface portion 156 is formed so as to extend in the width direction from the lower end of the side surface connecting portion 158 toward the side surface 114 of the lower case 110 (toward the left direction in FIG. 1, that is, toward the center side of the vehicle). The side surface connecting portion 158 is connected to the side surface 114 of the lower case 110 by joining, fastening, or the like.

The outer reinforcement 160 is fixed to the bottom surface 112 and the side surface 114 of the lower case 110 on the outside of the lower case 110. The outer reinforcement 160 is formed in a bent plate shape. The outer reinforcement 160 includes a bottom surface connecting portion 162, a lower surface portion 163, a side wall portion 164, an upper surface portion 166, and a side surface connecting portion 168. The bottom surface connecting portion 162 is formed so as to extend in the width direction along the bottom surface 112 of the lower case 110. The bottom surface connecting portion 162 is connected to the bottom surface 112 of the lower case 110 by joining, fastening, or the like. The lower surface portion 163 is formed so as to extend in the width direction from the end portion of the bottom surface connecting portion 162 on the side of the side surface 114 of the lower case 110 (the end portion on the right side in FIG. 1, that is, the end portion on the side surface side of the vehicle) toward a distance from the side surface 114 of the lower case 110. That is, the lower surface portion 163 is formed so as to extend in the width direction from the end portion of the bottom surface connecting portion 162 on the side surface 114 of the lower case 110 toward the right direction in FIG. 1, that is, toward the side surface side of the vehicle. The side wall portion 164 is formed so as to extend upward from an end portion of the lower surface portion 163 on the side surface side of the vehicle. The upper surface portion 166 is formed so as to extend in the width direction from the upper end of the side wall portion 164 toward the side surface 114 of the lower case 110 (in the left direction in FIG. 1, that is, toward the center side of the vehicle). The side surface connecting portion 168 is formed so as to extend upward along the side surface 114 of the lower case 110 from an end portion of the upper surface portion 166 on the side surface 114 of the lower case 110 (a left end portion in FIG. 1, that is, an end portion on the center side of the vehicle). That is, the upper surface portion 166 is formed so as to extend in the width direction away from the lower end of the side surface connecting portion 168 from the side surface 114 of the lower case 110 (in the right direction in FIG. 1, that is, toward the side surface side of the vehicle). The side surface connecting portion 168 is connected to the side surface 114 of the lower case 110 by joining, fastening, or the like.

With the above-described configuration, the inner reinforcement 150 and the outer reinforcement 160 are formed on the side surface 114 and the bottom surface 112 of the lower case 110 so that the inner reinforcement 150 and the outer reinforcement 160 sandwich the lower case 110. That is, the inner reinforcement 150 and the outer reinforcement 160 are formed to hold the lower case 110 in the side surface 114 and the bottom surface 112 of the lower case 110. Here, the bottom surface connecting portion 152 of the inner reinforcement 150 and the bottom surface connecting portion 162 of the outer reinforcement 160 may be connected at the same position with the bottom surface 112 of the lower case 110 interposed therebetween. Similarly, the side surface connecting portion 158 of the inner reinforcement 150 and the side surface connecting portion 168 of the outer reinforcement 160 may be connected at the same position with the side surface 114 of the lower case 110 interposed therebetween. Here, the inner reinforcement 150, the outer reinforcement 160, and the lower case 110 may be formed of metal. In this case, the bottom surface connecting portion 152 of the inner reinforcement 150, the bottom surface connecting portion 162 of the outer reinforcement 160, and the bottom surface 112 of the lower case 110 may be joined to each other by three-sheet welding (three-sheet spot welding). Similarly, the side surface connecting portion 158 of the inner reinforcement 150, the side surface connecting portion 168 of the outer reinforcement 160, and the side surface 114 of the lower case 110 may be joined to each other by three-sheet lap welding (three-sheet spot welding). With such a configuration, since the lower case 110 is sandwiched between the inner reinforcement 150 and the outer reinforcement 160, the lower case 110 can be protected (reinforced).

The battery stack bracket 170 is fixed to the end plate 104 and the inner reinforcement 150. The battery stack bracket 170 is formed in a curved plate shape. The battery stack bracket 170 includes a plate connecting portion 172 and a reinforcement connecting portion 174. The plate connecting portion 172 is formed so as to extend in the up-down direction along the end plate 104. The plate connecting portion 172 is connected to the end plate 104. The reinforcement connecting portion 174 is formed so as to extend in the width direction along the upper surface portion 156 of the inner reinforcement 150. The reinforcement connecting portion 174 is connected to the upper surface portion 156 of the inner reinforcement 150.

The vehicle mounting bracket 180 is formed in a bent plate shape. The vehicle mounting bracket 180 includes a lower surface portion 182, a side wall portion 184, and a vehicle body connecting portion 188. The lower surface portion 182 is formed to extend in the width direction along the lower surface portion 163 of the outer reinforcement 160. The lower surface portion 182 is connected to the lower surface portion 163 by joining or fastening. The lower surface portion 163 of the outer reinforcement 160, the lower surface portion 182 of the vehicle mounting bracket 180, and the share panel 140 may be connected to each other by joining or fastening at the same position. The side wall portion 184 is formed so as to extend upward from an end portion of the lower surface portion 182 on the side surface side of the vehicle. The side wall portion 184 is connected to the side wall portion 164 of the outer reinforcement 160 by joining or fastening. The vehicle body connecting portion 188 is formed continuously from the upper end of the side wall portion 184, and is attached to the vehicle body 10 by the vehicle body connecting member 190.

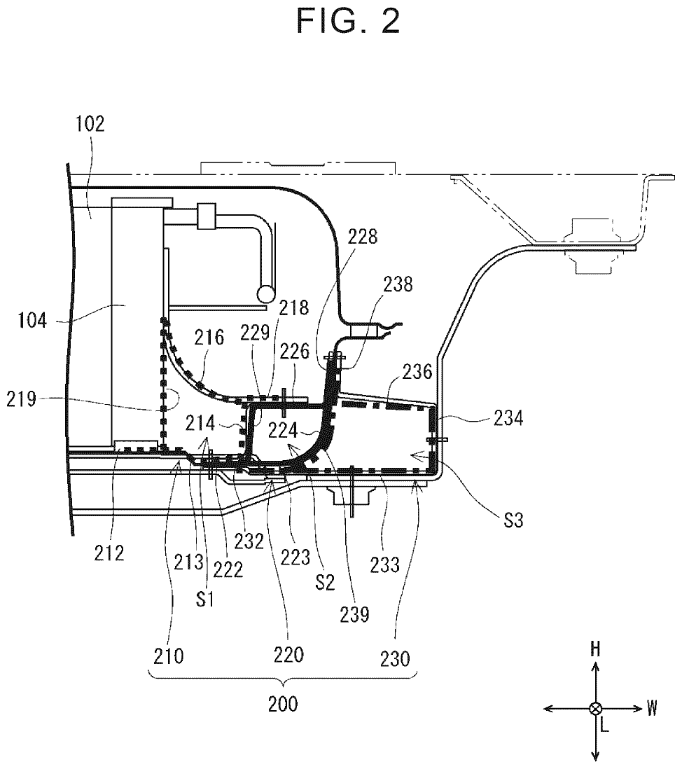

FIG. 2 is a diagram illustrating a closed cross-sectional structure 200 formed in an in-vehicle battery pack structure 100 according to Embodiment 1. The closed cross-sectional structure 200 has a first closed cross-section structure 210, a second closed cross-sectional structure 220, and a third closed cross-sectional structure 230.

As shown by the thick broken lines in FIG. 2, the end plate 104, the battery stack bracket 170, the inner reinforcement 150, and the lower case 110 form a first closed cross-sectional structure 210 having a closed cross-sectional structure when viewed from the front-rear direction of the vehicle. A space S1 is formed by the first closed cross-sectional structure 210. The first closed cross-sectional structure 210 includes a first protruding portion 212, a lower surface portion 213, an outer side wall portion 214, an upper surface portion 216, a second protruding portion 218, and an inner side wall portion 219. The first protruding portion 212 is a portion protruding from a portion forming the space S1, and corresponds to a portion where the lower case 110 and the end plate 104 are bonded to each other. The lower surface portion 213 corresponds to the bottom surface 112 of the lower case 110 and the bottom surface connecting portion 152 of the inner reinforcement 150. The outer side wall portion 214 is a side wall of the first closed cross-sectional structure 210 on the side surface side of the vehicle, and corresponds to the side wall portion 154 of the inner reinforcement 150. The upper surface portion 216 corresponds to the battery stack bracket 170. The second protruding portion 218 is a portion protruding from a portion forming the space S1, and corresponds to the reinforcement connecting portion 174 of the battery stack bracket 170. The inner side wall portion 219 is a side wall on the center side of the vehicle of the first closed cross-sectional structure 210 and corresponds to the end plate 104.

As shown by the thick solid line in FIG. 2, the inner reinforcement 150 and the lower case 110 form a second closed cross-sectional structure 220 having a closed cross-sectional structure when viewed from the front-rear direction of the vehicle. A space S2 is formed by the second closed cross-sectional structure 220. The second closed cross-sectional structure 220 includes a first protruding portion 222, a lower surface portion 223, an outer side wall portion 224, an upper surface portion 226, a second protruding portion 228, and an inner side wall portion 229. The first protruding portion 222 is a portion protruding from a portion forming the space S2, and corresponds to the bottom surface 112 of the lower case 110 and the bottom surface connecting portion 152 of the inner reinforcement 150. The lower surface portion 223 corresponds to the bottom surface 112 of the lower case 110. The outer side wall portion 224 is a side wall of the second closed cross-sectional structure 220 on the side surface side of the vehicle, and corresponds to the side surface 114 of the lower case 110. The upper surface portion 226 corresponds to the upper surface portion 156 of the inner reinforcement 150. The second protruding portion 228 is a portion protruding from a portion forming the space S2, and corresponds to the side surface connecting portion 158 of the inner reinforcement 150. The inner side wall portion 229 is a side wall on the center side of the vehicle of the second closed cross-sectional structure 220 and corresponds to the side wall portion 154 of the inner reinforcement 150.

Further, as indicated by the thick dashed-dotted line in FIG. 2, the lower case 110 and the outer reinforcement 160 form a third closed cross-sectional structure 230 having a closed cross-sectional structure when viewed from the front-rear direction of the vehicle. A space S3 is formed by the third closed cross-sectional structure 230. The third closed cross-sectional structure 230 includes a first protruding portion 232, a lower surface portion 233, an outer side wall portion 234, an upper surface portion 236, a second protruding portion 238, and an inner side wall portion 239. The first protruding portion 232 is a portion protruding from a portion forming the space S3, and corresponds to the bottom surface connecting portion 162 of the outer reinforcement 160. The lower surface portion 233 corresponds to the lower surface portion 163 of the outer reinforcement 160. The outer side wall portion 234 is a side wall of the third closed cross-sectional structure 230 on the side surface side of the vehicle, and corresponds to the side wall portion 164 of the outer reinforcement 160. The upper surface portion 236 corresponds to the upper surface portion 166 of the outer reinforcement 160. The second protruding portion 238 is a portion protruding from a portion forming the space S3, and corresponds to the side surface connecting portion 168 of the outer reinforcement 160. The inner side wall portion 239 is a side wall of the third closed cross-sectional structure 230 on the center side of the vehicle, and corresponds to the side surface 114 of the lower case 110.

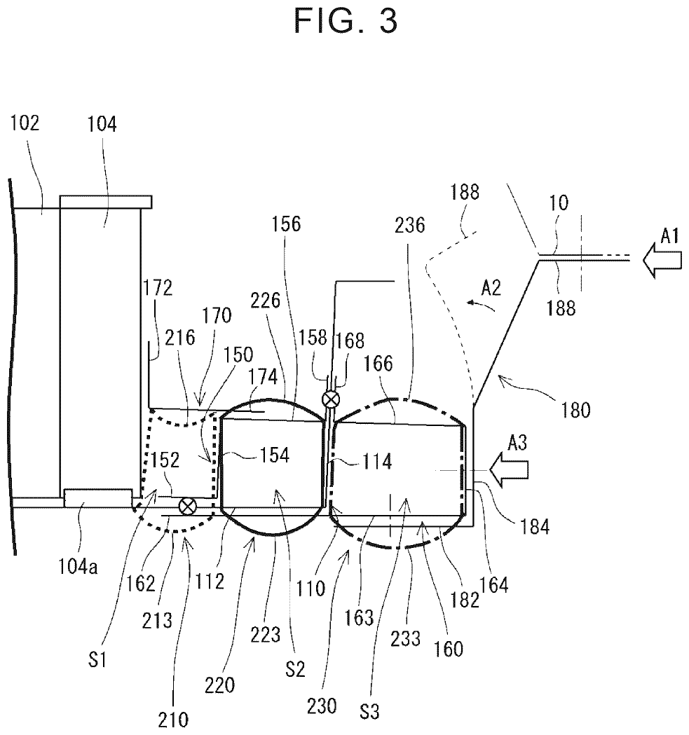

FIG. 3 is a diagram for describing the behavior of the in-vehicle battery pack structure 100 when an impact load is applied to the vehicle from the side surface in the first embodiment. As indicated by the arrow A1, an impact load is applied to the vehicle body 10 from the side surface toward the center due to a collision with the side surface of the vehicle or the like. As a result, as indicated by the arrow A2, the vehicle body connecting portion 188 of the vehicle mounting brackets 180 is deformed toward the center of the vehicle. As a result, as indicated by the arrow A3, an impact load from the side surface toward the center is applied to the side wall portion 184 of the vehicle mounting brackets 180.

Here, as described above, the side wall portion 184 of the vehicle mounting bracket 180 is connected to the side wall portion 164 of the outer reinforcement 160. Accordingly, an impact load is transmitted to the side wall portion 164 of the outer reinforcement 160, and the outer reinforcement 160 (the third closed cross-sectional structure 230) is deformed so as to collapse in the direction indicated by the arrow A3. Specifically, the lower surface portion 163 and the upper surface portion 166 of the outer reinforcement 160 are buckled and deformed in the direction indicated by the arrow A3. Therefore, as indicated by the thick chain line, the lower surface portion 233 of the third closed cross-sectional structure 230 may be deformed so as to bend downward, and the upper surface portion 236 may be deformed so as to bend upward. In this way, the third closed cross-sectional structure 230 is deformed to collapse in the width direction.

As described above, the bottom surface connecting portion 162 of the outer reinforcement 160 and the bottom surface connecting portion 152 of the inner reinforcement 150 are connected to the bottom surface 112 of the lower case 110. As described above, the side surface connecting portion 168 of the outer reinforcement 160 and the side surface connecting portion 158 of the inner reinforcement 150 are connected to the side surface 114 of the lower case 110. Accordingly, in response to the deformation of the third closed cross-sectional structure 230 (the outer reinforcement 160), an impact load is applied to the second closed cross-sectional structure 220 in the direction indicated by the arrow A3. Accordingly, the second closed cross-sectional structure 220 is deformed to collapse in the direction indicated by the arrow A3. Specifically, the bottom surface 112 of the lower case 110 and the upper surface portion 156 of the inner reinforcement 150 are buckled and deformed in the direction indicated by the arrow A3. Therefore, as indicated by the thick solid line, the lower surface portion 223 of the second closed cross-sectional structure 220 may be deformed so as to bend downward, and the upper surface portion 226 may be deformed so as to bend upward. In this way, the second closed cross-sectional structure 220 is deformed to collapse in the width direction.

As described above, the bottom surface connecting portion 152 of the inner reinforcement 150 is connected to the bottom surface 112 of the lower case 110. Further, as described above, the reinforcement connecting portion 174 of the battery stack bracket 170 is connected to the upper surface portion 156 of the inner reinforcement 150. Accordingly, in accordance with the deformation of the second closed cross-sectional structure 220 (the lower case 110 and the inner reinforcement 150), an impact load in the direction indicated by the arrow A3 is applied to the first closed cross-sectional structure 210. Accordingly, the first closed cross-sectional structure 210 is deformed to collapse in the direction indicated by the arrow A3. Specifically, the bottom surface 112 of the lower case 110 is buckled and deformed in the direction indicated by the arrow A3 together with the bottom surface connecting portion 152 of the inner reinforcement 150. Further, the battery stack bracket 170 is bent and deformed. Therefore, as indicated by the thick broken line, the lower surface portion 213 of the first closed cross-sectional structure 210 is deformed so as to bend downward, and the upper surface portion 216 is deformed so as to bend downward. In this way, the first closed cross-sectional structure 210 is deformed to collapse in the width direction.

Here, as described above, in the present embodiment, the closed cross-sectional structure 200 having the first closed cross-sectional structure 210, the second closed cross-sectional structure 220, and the third closed cross-sectional structure 230 is provided on the side surface side of the battery stack 102. The rigidity of the end plate 104 is higher than that of each of the lower case 110, the inner reinforcement 150, the outer reinforcement 160, the battery stack bracket 170, and the vehicle mounting bracket 180. In addition, since the first closed cross-sectional structure 210, the second closed cross-sectional structure 220, and the third closed cross-sectional structure 230 are box-shaped structures, they can be easily deformed. Therefore, the closed cross-sectional structure 200 is a structure that collapses during a period from when the vehicle body 10 is deformed due to an impact load applied to a side surface of the vehicle until when an impact load is applied to the end plate 104. Therefore, before the first closed cross-sectional structure 210, the second closed cross-sectional structure 220, and the third closed cross-sectional structure 230 are deformed as described above, there is a very low possibility that an impact load is applied to the end plate 104 and the end plate 104 is deformed. Therefore, even when an impact load is applied to the side surface of the vehicle, the impact load is suppressed from being applied to the battery stack 102. That is, since the impact energy can be absorbed by the closed cross-sectional structure 200 provided on the side surface of the battery stack 102, deformation of the battery stack 102 can be suppressed. This makes it possible to appropriately protect the battery stack 102.

Further, a first closed cross-sectional structure 210, a second closed cross-sectional structure 220, and a third closed cross-sectional structure 230, which are a plurality of closed cross-sectional structures, are provided in series on the side surface side of the battery stack 102. Therefore, it is possible to secure a distance S in which the deformation proceeds to the end plate 104 after the deformation of the vehicle body 10 caused by the impact load applied to the side surface of the vehicle. Therefore, even if the length of the battery stack 102 in the width direction is increased, it is possible to suppress the impact load from being applied to the battery stack 102 when the impact load is applied to the side surface of the vehicle. Here, a case where such a plurality of closed cross-sectional structures are not provided on the side surface of the battery stack 102 will be considered. In such a case, in order to prevent the impact load from being applied to the battery stack 102 as much as possible even when the vehicle body 10 is deformed by being applied to the impact load on the side surface of the vehicle, it is necessary to reduce the length of the battery stack 102 in the width direction. That is, it is necessary to make the distance from the side surface of the vehicle to the side surface of the battery stack 102 as long as possible. In contrast, in the present embodiment, a plurality of closed cross-sectional structures are provided on the side surfaces of the battery stack 102. Therefore, even if the length of the battery stack 102 in the width direction is increased and the distance between the end plate 104 and the vehicle body connecting member 190 is shortened, impact energy can be absorbed. Therefore, even if the length of the battery stack 102 in the width direction is increased and the distance between the end plate 104 and the vehicle body connecting member 190 is shortened, it is possible to suppress the load applied to the battery stack 102.

In addition, the resistance force F against the impact load from the side surface direction of the vehicle increases as the number of closed cross-sectional structures increases. Therefore, as in the present embodiment, the first closed cross-sectional structure 210, the second closed cross-sectional structure 220, and the third closed cross-sectional structure 230, which are a plurality of closed cross-sectional structures, are provided in series on the side surface side of the battery stack 102, so that the resistance force F can be increased. Therefore, even when an impact load is applied to the side surface of the vehicle, it is possible to suppress the amount of intrusion in which deformation progresses up to the battery stack 102.

In the present embodiment, the outer reinforcement 160 is provided outside the lower case 110. As a result, the third closed cross-sectional structure 230 is formed outside the lower case 110. The vehicle mounting bracket 180 is connected to the side wall portion 164 of the outer reinforcement 160. Therefore, when the vehicle body 10 and the vehicle mounting bracket 180 are deformed by being applied to the impact load on the side surface of the vehicle, the impact energy can be absorbed at a stage before the impact load is applied to the lower case 110. Therefore, the battery stack 102 accommodated in the lower case 110 can be appropriately protected.

In the present embodiment, the end plate 104 and the lower case 110 are bonded to each other. Accordingly, even when the bottom surface 112 of the lower case 110 is deformed due to an impact load from the side surface direction of the vehicle, it is possible to suppress the lower case 110 being deformed on the lower surface of the end plate 104. That is, even when the first closed cross-sectional structure 210 is deformed by the impact load from the side surface direction of the vehicle, it is possible to suppress the lower case 110 being deformed on the lower surfaces of the end plate 104 and the battery stack 102. Therefore, it is possible to suppress a load being applied to the battery stack 102 from the downward direction due to the influence of an impact load from the side surface direction of the vehicle.

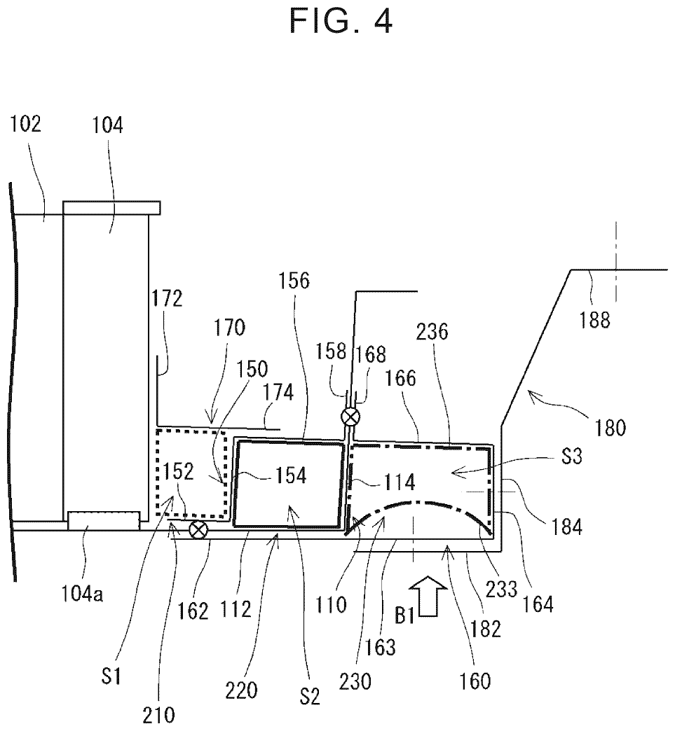

FIG. 4 is a diagram for describing the behavior of the in-vehicle battery pack structure 100 when an impact load is applied to the vehicle from the lower surface in the first embodiment. As indicated by the arrow B1, an impact load is applied to the vehicle body 10 from the lower surface upward due to road surface interference or the like of the vehicle. Accordingly, the lower surface portion 163 of the outer reinforcement 160 is deformed. That is, the lower surface portion 233 of the third closed cross-sectional structure 230 is deformed as indicated by the thick chain line. Here, since the space S3 is provided by the third closed cross-sectional structure 230, even if the lower surface portion 233 is deformed, the upper surface portion 236 is extremely unlikely to be deformed. Therefore, the entire closed cross-sectional structure 200 is prevented from being deformed, so that a load is prevented from being applied to the battery stack 102.

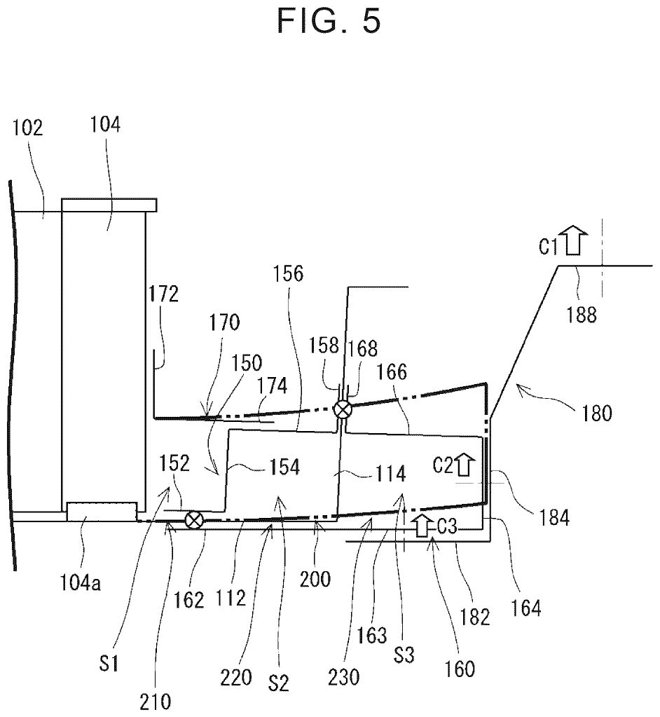

FIG. 5 is a diagram for describing the behavior of the in-vehicle battery pack structure 100 when vibration occurs in the vehicle in the first embodiment. As indicated by the arrow C1, it is assumed that an upward load is applied to the vehicle body 10 due to vibrations of the vehicle. In this case, the vehicle body connecting portion 188 of the vehicle mounting bracket 180 moves upward. Here, as described above, the side wall portion 184 of the vehicle mounting bracket 180 is connected to the side wall portion 164 of the outer reinforcement 160, and the lower surface portion 182 of the vehicle mounting bracket 180 is connected to the lower surface portion 163 of the outer reinforcement 160. Accordingly, the side wall portion 164 of the outer reinforcement 160 moves as indicated by the arrow C2, and the lower surface portion 163 of the outer reinforcement 160 moves as indicated by the arrow C3. As a result, the third closed cross-sectional structure 230 moves upward.

Here, as described above, the inner reinforcement 150 and the outer reinforcement 160 are formed on the side surface 114 and the bottom surface 112 of the lower case 110 so that the inner reinforcement 150 and the outer reinforcement 160 sandwich the lower case 110. Accordingly, the first closed cross-sectional structure 210, the second closed cross-sectional structure 220, and the third closed cross-sectional structure 230 may be integrally deformed. That is, as indicated by the thick two-dot chain line in FIG. 5, the closed cross-sectional structure 200 deflects upward like a cantilever beam starting from a portion connected to the end plate 104. Here, since the inner reinforcement 150 and the outer reinforcement 160 have a structure in which multiple plates overlap each other at a position where the lower case 110 is sandwiched therebetween, deformation is suppressed. Further, since the first closed cross-sectional structure 210, the second closed cross-sectional structure 220, and the third closed cross-sectional structure 230 are to be integrally deformed (moved), deformation (plastic deformation) of the closed cross-sectional structure 200 is suppressed. In such a situation, it is extremely difficult for the first closed cross-sectional structure 210, the second closed cross-sectional structure 220, and the third closed cross-sectional structure 230 to be independently deformed, so that the rigidity of the closed cross-sectional structure 200 can be secured. Therefore, the stress generated in the vehicle body connecting member 190 and the end plate 104 can be reduced. The same applies to a case where a downward load is applied to the vehicle body 10 due to vibration of the vehicle.

### Modification

The present disclosure is not limited to the above-described embodiments, and can be appropriately modified without departing from the spirit. For example, the lower surface portion 182 of the vehicle mounting bracket 180 need not be connected to the lower surface portion 163 of the outer reinforcement 160.

In addition, the inner reinforcement 150, the outer reinforcement 160, and the battery stack bracket 170 may have a structure that increases the rigidity to an extent that the rigidity is not higher than the rigidity of the end plate 104. For example, at least one of the side wall portion 154 and the upper surface portion 156 of the inner reinforcement 150 may have a double structure. In addition, the upper surface portion 166 of the outer reinforcement 160 may have a double structure. Further, the reinforcement connecting portion 174 of the battery stack bracket 170 may have a double structure.

What is claimed is:

1. An in-vehicle battery pack structure comprising:
a battery stack;
an end plate disposed on a side surface of the battery stack and fixed to a lower case that accommodates the battery stack;
an inner reinforcement formed in a bent plate shape and fixedly disposed on an inner side of the lower case;
an outer reinforcement formed in a bent plate shape and fixedly disposed on an outer side of the lower case so as to face the inner reinforcement with a wall surface of the lower case sandwiched therebetween;
a battery stack bracket that couples the end plate and the inner reinforcement; and
a vehicle mounting bracket fixed to the outer reinforcement on at least a side wall of the outer reinforcement and attached to a vehicle body, wherein
the end plate is formed such that a rigidity of the end plate is higher than a rigidity of each of the lower case, the inner reinforcement, the outer reinforcement, the battery stack bracket, and the vehicle mounting bracket.

2. The in-vehicle battery pack structure according to claim 1, wherein:
a first closed cross-sectional structure having a closed cross-sectional structure is formed by the end plate, the battery stack bracket, the inner reinforcement, and the lower case;
a second closed cross-sectional structure having a closed cross-sectional structure is formed by the inner reinforcement and the lower case; and
a third closed cross-sectional structure having a closed cross-sectional structure is formed by the lower case and the outer reinforcement.

3. The in-vehicle battery pack structure according to claim 2, wherein the inner reinforcement and the outer reinforcement are formed such that the inner reinforcement and the outer reinforcement sandwich the lower case on a side surface and a bottom surface of the lower case.
